(19) United States
(12) Patent Application Publication
(10) Pub. No.: US 2025/0376854 A1
(43) Pub. Date: Dec. 11, 2025

(54) Flooring Membrane

(71) Applicant: Schluter Systems L.P., Plattsburgh, NY (US)

(72) Inventor: Marc Schluter, Iserlohn (DE)

(21) Appl. No.: 18/982,627

(22) Filed: Dec. 16, 2024

(30) Foreign Application Priority Data
Jun. 11, 2024 (DE) 202024103091.5

(51) Int. Cl. E04F 15/18; B32B 3/30; B32B 7/12; B32B 27/00

(52) U.S. Cl. CPC E04F 15/185; B32B 3/30; B32B 7/12; B32B 27/00; B32B 2307/7246; B32B 2307/7265; B32B 2307/7376; B32B 2419/00

(57) ABSTRACT

A flooring membrane (1) includes a water- and water-vapor-impermeable flexible plastic layer (4) of film-like plastic having an upper side (5) and an underside (6), and an anchoring layer (11) firmly bonded to the underside (6) of the plastic layer (4). The plastic layer includes a plurality of nubs (7) present on the upper side, each of the nubs forming a nub cavity (8) on the lower side. Water or water vapor discharge channels (9) are formed on the lower side of the plastic layer (4). A maximum height (hₘₐₓ) of the membrane (1) is at most about 5 mm, and at least 200 nubs per 10 cm² are provided in areas having nubs (7).

### PRIORITY CLAIM

Priority is claimed of and to German Patent Application Serial No. 20 2024 103 091.5, filed Jun. 11, 2024, which is hereby incorporated herein by reference in its entirety.

### BACKGROUND OF THE INVENTION

### Field of the Invention

The present technology relates generally to a mat or sheet or membrane having a water- and water vapor-impermeable flexible plastic layer of film-like plastic having an upper side and an underside, and an anchoring layer firmly bonded to the underside of the plastic layer. The technology further relates to a floor structure including a screed layer, a vapor pressure equalization layer laid directly on the screed layer and a floor covering laid on the vapor pressure equalization layer.

### SUMMARY OF THE INVENTION

In accordance with one aspect of the technology, a flooring membrane (1) is provided. The membrane can include a water- and water-vapor-impermeable flexible plastic layer (4) of film-like plastic, which can have an upper side (5) and an underside (6), and an anchoring layer (11) firmly bonded to the underside (6) of the plastic layer (4). The plastic layer (4) can include a plurality of nubs (7) present on the upper side, each of the nubs forming a nub cavity (8) on the lower side. Water or water vapor discharge channels (9) can be formed on the lower side of the plastic layer (4). A maximum height (hₘₐₓ) of the membrane (1) can be at most about 5 mm, and at least 200 nubs per 10 cm² can be provided in areas having nubs (7).

In accordance with another aspect of the technology, a floor structure (12) is provided, including a screed layer (14), a vapor pressure equalization layer (15) laid directly on the screed layer (14), and a floor covering (16) laid on the vapor pressure equalization layer (15). The vapor pressure equalization layer (15) can be formed from a plurality of membranes (1), each membrane (1) including a plastic layer (4), arranged adjacent to one another, with edge regions of plastic layers (4) of membranes (1) being arranged directly adjacent to one another and connected to one another in a water- and water-vapor-tight manner.

Additional features and advantages of the technology will be apparent from the detailed description which follows, taken in conjunction with the accompanying drawings, which together illustrate, by way of example, features of the invention.

### BRIEF DESCRIPTION OF THE DRAWINGS

FIG. 1 is a perspective top view of a central section of a mat according to one embodiment of the present technology;

FIG. 2 is a perspective bottom view of the section shown in FIG. 1;

FIG. 3 a top view of the section shown in FIG. 1;

FIG. 4 a side view of the section shown in FIG. 1;

FIG. 5 a top view of edge areas of two adjacent mats;

FIG. 6 a side view of the view shown in FIG. 5; and

FIG. 7 a sectional view of a floor structure according to an embodiment of the present technology, which comprises a plurality of the mats shown in FIGS. 1 to 6.

The same reference numbers relate hereafter to identical or similar components or component ranges.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### Definitions

As used herein, the singular forms “a” and “the” can include plural referents unless the context clearly dictates otherwise. Thus, for example, reference to “a nub” can include one or more of such nubs, if the context dictates.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item so long as there is no measurable effect as a result thereof.

As used herein, the term “about” is used to provide flexibility to a numerical range endpoint by providing that a given value may be “a little above” or “a little below” the endpoint.

Relative directional terms can sometimes be used herein to describe and claim various components of the present invention. Such terms include, without limitation, “upward,” “downward,” “horizontal,” “vertical,” etc. These terms are generally not intended to be limiting, but are used to most clearly describe and claim the various features of the invention. Where such terms must carry some limitation, they are intended to be limited to usage commonly known and understood by those of ordinary skill in the art in the context of this disclosure. Generally, directional terms used in this application, such as “top” or “bottom” refer to the installed state. The formulations “substantially vertical” and “substantially horizontal” are to be construed such that the main extension direction is vertical and horizontal, respectively.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

### Invention

Indoor floors often have a screed layer on which the actual floor covering is laid. The screed layer can serve to create a planar substrate for laying the floor covering, and it can serve as a load distribution layer under which underfloor heating and thermal and impact sound insulation can be installed. One problem with creating a screed layer is that it can take a very long time to dry. A drying time of normally one week per 1 cm of screed thickness is often expected. Drying takes even longer for thicker screed layers. Accordingly, due to the stresses arising in the screed layer during drying and the moisture rising from the screed layer, it is often necessary to wait a long time before the floor covering can be laid on the screed layer.

In the case of moisture-resistant floor coverings, such as tiles, the waiting time can be reduced by laying a so-called decoupling layer between the screed and the floor covering, which absorbs the stresses arising within the screed layer so that the stresses are not transferred to the floor covering and can destroy it. A decoupling layer can be formed using a decoupling mat, which is bonded to the screed layer using a tile adhesive, after which the tiles are laid on the decoupling mat, also using a tile adhesive. For this purpose, decoupling mats can comprise a flexible plastic layer made of film-like plastic and an anchoring layer firmly attached to the underside of the plastic layer, with which the mat is anchored to the screed. The plastic layer can be structured in such a way that indentations are formed on the upper side, which are surrounded by channels on the underside.

As an example, reference is made to the decoupling mat or membrane marketed by the applicant under the product name “DITRA.” When laying the tiles, the indentations are filled with tile adhesive which, after drying, forms stilt-shaped supports via which the loads acting on the floor covering are transferred to the screed layer. The channels formed on the underside of the plastic layer provide the stilt-shaped supports with a movement clearance that can be used to relieve any stresses that occur. In addition, rising moisture from the screed layer can be directed to the side edge of the decoupling mat via these channels. The use of such decoupling mats has proven its worth in the past. One disadvantage, however, is that the tile adhesive layer, which must be applied above the decoupling mat for laying the tiles, must often be several millimeters thick, as it forms a load distribution layer, via which the loads later acting on the floor covering are transferred to the screed layer via the stilt-shaped supports. This is contrary to the frequent desire for floor structures with the lowest possible height.

When laying moisture-sensitive floor coverings, such as parquet, the screed layer must be allowed to dry completely to ensure that the floor covering is not damaged by rising moisture. When laying parquet, the use of a decoupling mat is generally not recommended. On the one hand, adhesives used for laying parquet are rather unsuitable for load transfer, unlike tile adhesives. Secondly, moisture can rise between adjacent decoupling mats and cause damage to the floor covering. Contrary to these issues with conventional systems, the present technology provides a mat or sheet and a floor structure of the type mentioned above with an alternative structure that avoids many problems encountered in the past.

In one example, the present technology creates a mat or sheet comprising a water- and water-vapor-impermeable flexible plastic layer of film-like plastic, which has an upper side and an underside, and an anchoring layer which is firmly bonded to the underside of the plastic layer and which can be a nonwoven fabric or a fabric layer, or a self-adhesive layer, the plastic layer being provided with a structure in such a way that nubs are present on the upper side, each of which forms a nub cavity on the lower side, and that water or water vapor discharge channels are formed on the lower side, wherein the maximum height of the mat or sheet is at most about 5 mm, in particular at most about 3 mm, and at least 200, in some embodiments at least 250, in other embodiments at least 350 nubs per 10 cm² are provided in areas having nubs.

In comparison to conventional decoupling mats, the plastic layer of the mat or sheet according to the present technology is not provided with individual indentations on its upper side, but with protruding nubs. Water or water vapor discharge channels are formed on the underside. Thanks to the high number of nubs and the low height of the mat or sheet according to the technology, the nubs are comparatively small and very stable. Accordingly, loads acting on the upper side of the plastic layer can be transferred to the underside via the nubs. The nubs themselves are therefore capable of bearing loads to the extent required for floor structures. Accordingly, if a tile covering is laid on the mat or sheet according to the present technology, the load transfer is achieved primarily via the nubs of the plastic layer and thus via the plastic layer itself. This means that an adhesive layer applied for laying the floor covering can be applied much thinner than when using conventional decoupling mats or, if the floor covering is laid loosely, can be omitted altogether, resulting in lower floor construction heights.

Rising moisture from the screed can be drained away via the water or water vapor discharge channels so that it cannot reach the floor covering arranged above the mat or sheet. Accordingly, a moisture-resistant floor covering, such as parquet, can also be laid on the mat or sheet according to the technology without any problems. The present technology avoids the need to wait for conventional drying times. The decoupling effect of the mat or sheet according to the technology is comparable to the decoupling effect of decoupling mats of the type described above, for example DITRA.

The thickness of the plastic layer, at least in the area of the nubs, can be at least about 0.3 mm: in one example it can be at least about 0.4 mm. Tests have shown that nubs with sufficient load-bearing capacity can be produced with such a thickness. Advantageously, the thickness of the plastic layer can be a maximum of 0.5 mm, which results in a low-cost structure. The structure can advantageously form a recurring pattern, which provides uniform properties.

The plastic layer can include rectangular outer dimensions when viewed from above, which are defined by two longitudinal edges extending in a longitudinal direction and two transverse edges extending in a transverse direction, the length of the longitudinal edges can correspond to a multiple of the length of the transverse edges. In addition, the essentially U-shaped plastic webs extending between the nubs, which define the water or water vapor discharge channels, form reinforcing struts that further increase the load-bearing capacity of the individual nubs.

Advantageously, the structure can be selected in such a way that the nub cavity of each nub is connected to the nub cavities of six immediately adjacent nubs in each case via a water or water vapor discharge channel. In this way, a very compact structure of the plastic layer is achieved.

In one example, when the plastic layer is viewed from above, the nubs can have a width or diameter of at most about 4 mm: in one example, the nubs can have a width or diameter of at most about 3 mm.

In one example, the nubs can be rounded, or oval, or circular, when the plastic layer is viewed from above. When viewed from above, the plastic layer can have rectangular external dimensions, which are defined by two longitudinal edges extending in a longitudinal direction and two transverse edges extending in a transverse direction, the length of the longitudinal edges can correspond to a multiple of the length of the transverse edges. When incorporating such measurements, the mat or sheet according to the present technology can be easily manufactured, transported, in particular as rolled goods, and laid.

Advantageously, the plastic layer can have at least one flat, nub-free edge section. Such edge sections allow adjacent mats or sheets to be easily joined together in a water- and water vapor-tight manner using sealing adhesive strips in order to create a vapor pressure equalization layer. Such flat edge sections can be provided along one, several or all edges of the plastic layer, in particular in the lower area of the plastic layer, so that they or an adhesive layer arranged on their underside rest on the substrate when laid. Edge regions or sections in one embodiment are provided along opposite longitudinal edges of the plastic layer. In one example, one edge region can be covered on the underside with the anchoring layer, while the other edge region is not provided with an anchoring layer.

The present technology also provides a floor structure that includes a screed layer, a vapor pressure equalization layer laid directly on the screed layer and a floor covering laid on the vapor pressure equalization layer. The vapor pressure equalization layer can be formed from a plurality of mats or sheets according to the technology arranged adjacent to one another, wherein edge regions of plastic layers of mats or sheets can be arranged directly adjacent to one another and are connected to one another in a water- and water-vapor-tight manner, by utilizing, for example, sealing adhesive strips. The floor covering can be arranged directly on the vapor pressure equalization layer. Alternatively, it is also possible to provide an intermediate layer between the vapor pressure equalization layer and the floor covering, such as a levelling compound or the like.

The vapor pressure equalization layer can be arranged loosely on the screed layer or firmly bonded to the screed layer using an adhesive. The floor covering can be arranged loosely on the vapor pressure equalization layer or firmly or at least selectively firmly bonded to the vapor pressure equalization layer using an adhesive. The floor covering can be made of moisture-sensitive material, so that the advantages of the mats or sheets according to the technology are particularly effective. The mats or sheets of the present technology can be used to form a vapor pressure equalization layer, as part of, for example, a floor structure.

Further features and advantages of the present invention will become apparent from the following description of systems according to embodiments of the present invention with reference to the accompanying drawing. Hereinafter, same reference numbers refer to same or similar components or component areas.

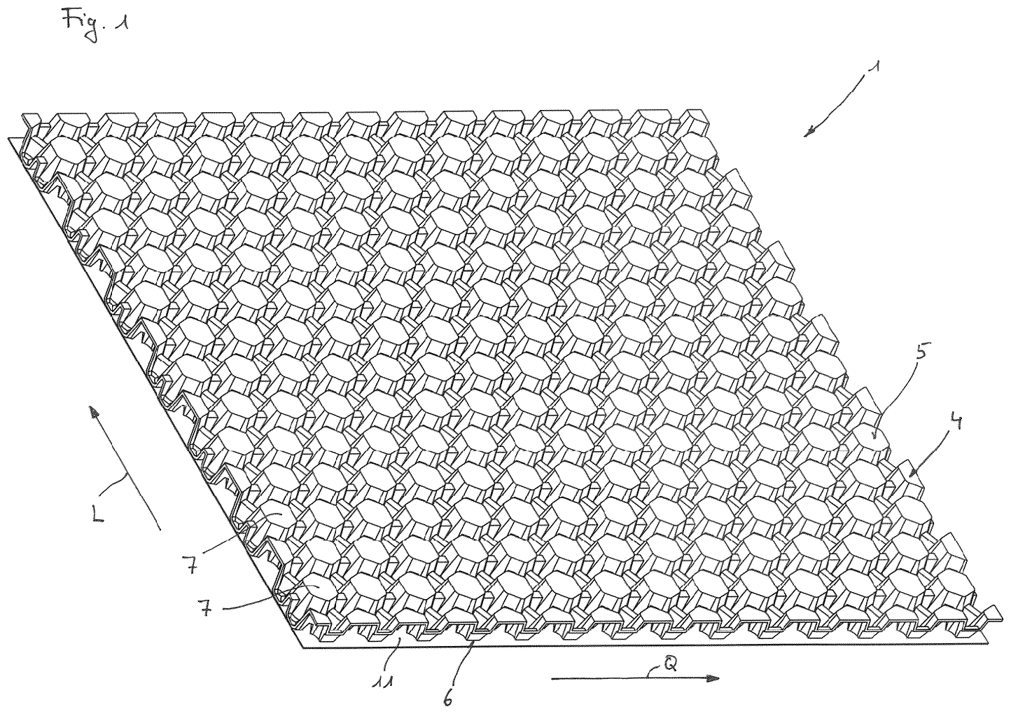

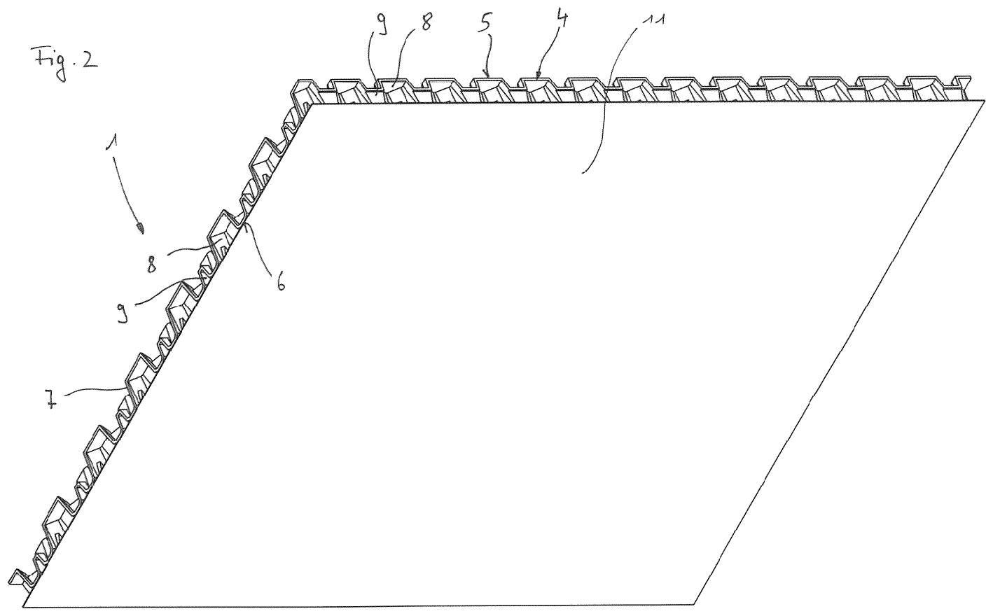

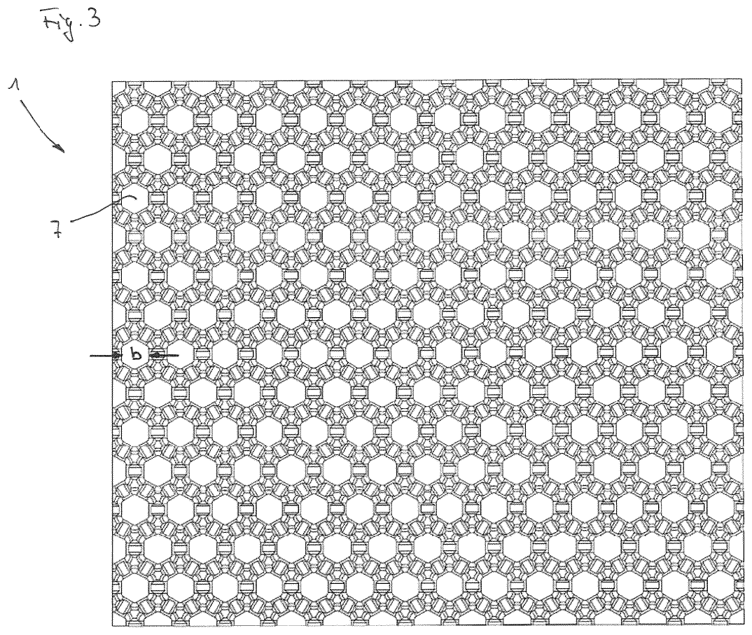

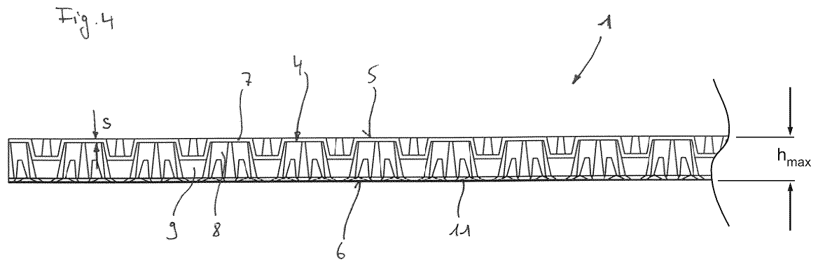

FIGS. 1 to 6 show sections of a mat or membrane 1 according to one embodiment of the present technology, which can be designed as a generally flat, sheet-like piece of material. Viewed from above, the mat 1 can have rectangular external dimensions which are defined by two longitudinal edges extending parallel to one another in a longitudinal direction L and two transverse edges extending parallel to one another in a transverse direction Q. The length of the longitudinal edges can correspond to a multiple of the length of the transverse edges. The width of the mat 1 from one longitudinal edge to the other can be in the range of about 40 to about 100 cm. The length of the mat 1 from one transverse edge to the other can be several meters, whereby the mat 1 can advantageously be supplied in rolls. The maximum height hₘₐₓ of the mat 1 can be a maximum of about 5 mm: in one example, the maximum height is about 3 mm.

The mat 1 can comprise a water- and water vapor-impermeable and flexible plastic layer 4, which can be made of a film-like plastic and can be devoid of perforations. The plastic layer 4 can have an upper side 5 and an underside 6 and can be structured in such a way that nubs 7 protrude on the upper side, each of which forms a nub cavity 8 on the underside, and that water or water vapor discharge channels 9 are formed on the underside. In one example, the structure can form or exhibit a recurring pattern in which each nub 7 has six nubs arranged directly adjacent and evenly distributed around the corresponding nub, whereby the nub cavities 8 of adjacent nubs 7 are each connected to each other via a water or water vapor discharge channel 9. In one example, at least 200, and sometimes at least 250, or other times at least 350 nubs per 10 cm² can be provided. When the plastic layer 4 is viewed from above, the nubs can be hexagonal in shape and can have a width b of at most 4 mm, or at most about 3 mm. The thickness of the plastic layer 4 can be at least about 0.3 mm, or at least about 0.4 mm, at least in the area of the nubs 7.

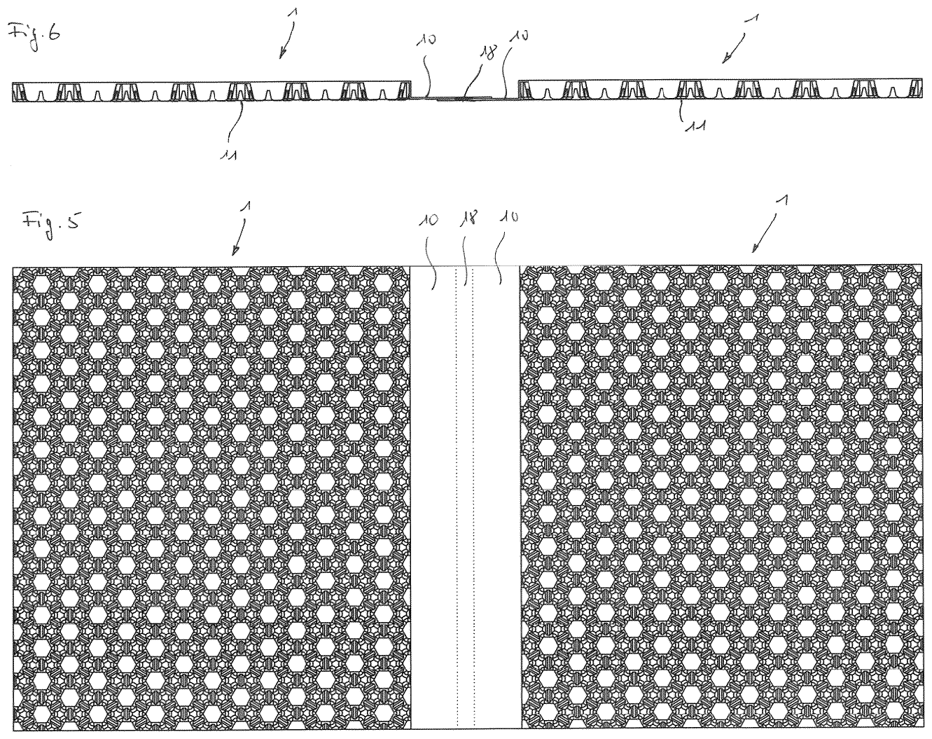

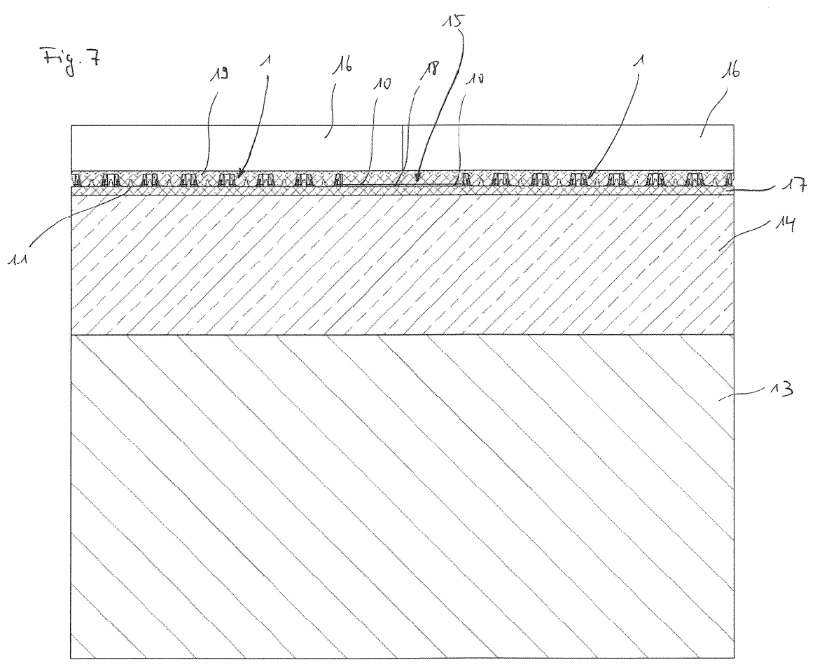

In the example shown in FIGS. 5 and 6, the plastic layer 4 can include nub-free and flat edge sections 10, which in this embodiment extend along both longitudinal edges and are arranged to overlap each other during laying. The edge sections 10 can be formed in the lower area of the plastic layer 4 so that they rest on the substrate when the mat 1 is laid on a substrate. A self-adhesive sealing strip 18 can extend along the entire longitudinal edge and can be arranged on the underside of one of the edge sections 10 and can be provided with a protective layer, not shown in detail, which can be removed before the mat 1 is laid.

In one example, the mat 1 can comprise an anchoring layer 11 that is firmly bonded to the underside 6 of the plastic layer 4, which is in one embodiment a non-woven or fabric layer. The anchoring layer 11 can essentially cover the entire underside 6 of the plastic layer 4. In one embodiment, only one of the edge sections 10 arranged opposite one another is covered by the anchoring layer. For example, in FIGS. 5 and 6, the edge section 10 provided with the sealing adhesive strip 18 on the left in the figure, is not covered by the anchoring layer. The anchoring layer 11 can be attached to the plastic layer 4 immediately after the plastic layer 4 has been produced by pressing the anchoring layer 11 onto the still hot, not fully cured plastic layer 4. Of course, other joining methods can also be utilized, such as welding, gluing or the like, which can also be carried out at a later time. A self-adhesive layer can also be provided as an anchoring layer 11, not shown in detail.

FIG. 7 shows a floor structure 12 according to an embodiment of the present technology that includes a screed layer 14 applied to a substrate 13, a vapor pressure equalization layer 15 laid directly on the screed layer 14 and a floor covering 16 laid on the vapor pressure equalization layer 15. The floor covering in this example is made of a moisture-sensitive material which, when exposed to moisture, is damaged or changes its external dimensions, in particular swells, such as parquet. The vapor pressure equalization layer 15 can be formed in the present case from a plurality of mats 1 of the type described above arranged adjacent to one another, which can be bonded to the screed layer 14 using an adhesive 17, for example tile adhesive. The edge sections 11 of plastic layers 4 of directly adjacent mats 1 can be connected to each other in a water- and water-vapor-tight manner, in the present case using sealing adhesive strips 18. The floor covering 16 is firmly connected to the vapor pressure equalization layer 15 in the present case using an adhesive 19, for example in the form of a commercially available parquet adhesive. In some embodiments, an intermediate layer (not shown) is provided between the vapor pressure equalization layer 15 and the floor covering 16, such as a levelling compound or the like.

Due to the high number of nubs 7 and the low height of the mat 1 according to the present technology, the nubs 7 are comparatively small and very stable. Accordingly, loads acting on the upper side of the plastic layer 4 can be transferred to the underside 6 via the nubs 7. The nubs 7 are therefore capable of bearing loads even to the extent required for floor structures. Thus, when a floor covering 16 is laid on the mat 1 according to the present technology, the load transfer is not achieved via the stilt-shaped supports formed by the adhesive 17, but instead via the nubs 7 of the plastic layer 4 and thus via the plastic layer 4 itself. This advantageously means that the adhesive layer applied for laying the floor covering 16 can be applied much thinner than when laying conventional decoupling mats, resulting in lower floor construction heights. Rising moisture from the screed is drained away via the water or water vapor discharge channels 9 so that it cannot reach the floor covering 16 arranged above the mat 1. Accordingly, a moisture-resistant floor covering 16, for example parquet, can also be laid on the mat 1 according to the technology without any problems. The conventional drying times for screed are thereby avoided.

In addition to the structure outlined above, the present technology also provides various methods of using, arranging, and attaching various membranes (1) for forming floor structures and vapor pressure equalization layers in floor structures.

It will be recognized that embodiments of membranes and floor structures in accordance with the technology are not limited to the above-described embodiments, and various modifications may be possible without departing from the scope of the technology as defined in the appended claims.

### REFERENCE NUMBERS

1 Mat or membrane or sheet
4 Plastic layer
5 Upper side
6 Underside
7 Nub
8 Nub cavity
9 Water or water vapor discharge channel
10 Edge section
11 Anchoring layer
12 Floor structure
13 Substrate
14 Screed layer
15 Vapor pressure equalization layer
16 Floor covering
17 Adhesive
18 Sealing adhesive strips
19 Adhesive
L Longitudinal direction
Q Transverse direction
d Diameter
s Thickness
a dimension
hₘₐₓ maximum height

I claim:

1. A flooring membrane (1) comprising:
a water- and water-vapor-impermeable flexible plastic layer (4) of film-like plastic, having:
an upper side (5) and an underside (6), and an anchoring layer (11) firmly bonded to the underside (6) of the plastic layer (4);
the plastic layer (4) having a plurality of nubs (7) present on the upper side, each of the nubs forming a nub cavity (8) on the lower side;
water or water vapor discharge channels (9) formed on the lower side of the plastic layer (4);
a maximum height (hₘₐₓ) of the membrane (1) being at most about 5 mm, and at least 200 nubs per 10 cm² are provided in areas having nubs (7).

2. The membrane (1) according to claim 1, wherein at least about 250 nubs per 10 cm² a provided.

3. The membrane (1) according to claim 1, wherein at least about 350 nubs per 10 cm² are provided.

4. The membrane (1) according to claim 1, wherein a maximum height (hₘₐₓ) of the mat or sheet (1) is at most about 3 mm.

5. The membrane (1) according to claim 1, wherein the thickness of the plastic layer (4) is at least about 0.3 mm.

6. The membrane (1) according to claim 1, wherein the thickness of the plastic is at least about 0.4 mm.

7. The membrane (1) according to claim 1, wherein the nubs (7) and channels (9) form a recurring pattern.

8. The membrane (1) according to claim 1, wherein the nub cavities (8) are connected to adjacent nubs (7) via the water or water vapor discharge channels (9).

9. The membrane (1) according to claim 1, wherein each nub cavity (8) of each nub (7) is connected to nub cavities (8) of six immediately adjacent nubs (7) via a water or water vapor discharge channel (9).

10. The membrane (1) according to claim 1, wherein the nubs (7), when the plastic layer (4) is viewed from above, have a width (b) or a diameter of at most about 4 mm.

11. The membrane (1) according to claim 1, wherein the nubs (7), when the plastic layer (4) is viewed from above, are rounded.

12. The membrane (1) according to claim 1, wherein the plastic layer (4) has rectangular outer dimensions when viewed from above, which are defined by two longitudinal edges (2) extending in a longitudinal direction and two transverse edges (3) extending in a transverse direction, the length of the longitudinal edges (2) corresponding to a multiple of the length of the transverse edges (3).

13. The membrane (1) according to claim 1, wherein the plastic layer (4) has at least one flat, nub-free edge section (10).

14. A floor structure (12), comprising:
a vapor pressure equalization layer (15) operable to be laid directly on a screed layer (14); and
a floor covering (16) laid on the vapor pressure equalization layer (15);
the vapor pressure equalization layer (15) being formed from a plurality of membranes (1), each membrane (1) including a plastic layer (4), arranged adjacent to one another, with edge regions of plastic layers (4) of membranes (1) being arranged directly adjacent to one another and connected to one another in a water- and water-vapor-tight manner.

15. The floor structure (12) according to claim 14, wherein the plastic layers (4) of the membranes (1) are connected to one another using sealing adhesive strips.

16. The floor structure (12) according to claim 14, wherein the vapor pressure equalization layer (15) is arranged loosely on the screed layer (14).

17. The floor structure (12) according to claim 14, wherein the vapor pressure equalization layer (15) is firmly bonded to the screed layer (14) using an adhesive (17).

18. The floor structure (12) according to claim 14, wherein the floor covering (16) is arranged loosely on the vapor pressure equalization layer (15).

19. The floor structure (12) according to claim 14, wherein the floor covering (16) is firmly bonded to the vapor pressure equalization layer (15) using an adhesive (17).

20. The floor structure (12) according to claim 14, wherein the floor covering (16) comprises moisture-sensitive material.

21. The floor structure (12) according to claim 14, further comprising a screed layer, positioned beneath the vapor pressure equalization layer (15).
